(19) United States
(12) Patent Application Publication
(10) Pub. No.: US 2026/0213042 A1
(43) Pub. Date: Jul. 23, 2026

(54) COAXIAL CABLE AND METHOD OF MANUFACTURING THE SAME

(71) Applicant: WildStar, LLC, Saratoga, CA (US)

(72) Inventors: Guan Che Ting, San Jose, CA (US); Jacob Miles Peery, Hermona Beach, CA (US)

(73) Assignee: WildStar, LLC, Saratoga, CA (US)

(21) Appl. No.: 19/427,663

(22) Filed: Dec. 19, 2025

Related U.S. Application Data
(60) Provisional application No. 63/747,119, filed on Jan. 20, 2025.

(51) Int. Cl. H01B 11/18; H01B 13/016

(52) U.S. Cl. CPC H01B 11/1804; H01B 13/0162; H01B 13/0165

(57) ABSTRACT

The disclosed technology is generally directed to a coaxial cable that includes an inner central conductor, an insulator layer disposed around the external wall of the inner central conductor, a shielding conductor disposed around the insulator layer, and an outer jacket surrounding the shielding conductor. The inner central conductor has an external wall and an internal wall defining an axial cavity extending along a longitudinal axis of the inner central conductor. The axial cavity reduces the material volume of the inner central conductor relative to a solid inner conductor of equivalent outer diameter, thereby reducing weight and/or cost of the coaxial cable.

### RELATED APPLICATIONS

This application claims the benefit of U.S. Provisional Application No. 63/747,119, filed on Aug. 7, 2025, which is incorporated herein by reference in its entirety.

### TECHNICAL FIELD

This disclosure is directed to electrical cables, and more particularly, to coaxial cables and methods for manufacturing the same.

### BACKGROUND

A coaxial cable is a type of electrical cable designed to transmit high-frequency signals with minimal interference and signal loss. For example, coaxial cables may be utilized for transmitting radio frequency (RF) signals with minimal interference and signal loss. The coaxial cables enable efficient signal transmission over various distances, making them important for telecommunications, television, internet, and many other applications.

A traditional coaxial cable includes an inner or central conductor, an insulator, a shielding conductor, and an outer jacket (also referred to as a sheath) that are concentrically arranged. To explain further, the central conductor may carry electrical signals and may provide a signal path to connect two different devices. The insulator may be made of a non-conductive material that surrounds the central conductor. The insulator ensures proper and consistent spacing between the central conductor and the shielding conductor, and provides insulation and the desired impedance value to reduce energy loss. The shielding conductor may provide electrical isolation and serve as a return path for signals. The shielding conductor may protect the central conductor from external electromagnetic interference (EMI). The outer jacket is a protective layer that may protect the coaxial cable from environmental factors like moisture, heat, and mechanical damage, while providing mechanical strength to the coaxial cable. The concentric arrangement of these components ensures that the electric and magnetic fields carrying the signal remain confined within the cable, preventing interference and maintaining signal integrity.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

In one aspect, an exemplary embodiment of the present disclosure may provide a coaxial cable. The coaxial cable comprises an inner central conductor, an insulator layer, a shielding conductor, and an outer jacket. The inner central conductor has an external wall and an internal wall defining an axial cavity extending along a longitudinal axis of the inner central conductor. In some implementations, the axial cavity is a hollow axial cavity that extends through the inner central conductor along the longitudinal axis, and the internal wall is formed in the inner central conductor to define the hollow axial cavity. The insulator layer may be disposed around the inner central conductor. For example, the insulator layer may be disposed around the external wall of the inner central conductor. The shielding conductor may be disposed around the insulator layer, and the outer jacket may surround the shielding conductor. For example, the shielding conductor may be disposed around an external periphery of the insulator layer. In some implementations, the insulator layer and the shielding conductor are disposed between the external wall and the outer jacket.

The axial cavity is an empty space defined within the inner central conductor that is filled with the surrounding medium, unless otherwise sealed or evacuated. Depending on deployment conditions and whether the axial cavity is sealed, the axial cavity may be in selective fluid communication with the surrounding environment, and may thus contain a gas, a liquid, or vacuum. For example, when the coaxial cable is deployed within the Earth's atmosphere and the axial cavity is unsealed, the axial cavity would be filled with air. By contrast, when the coaxial cable is deployed in space, the axial cavity may be exposed to a vacuum environment or may retain a gaseous medium if sealed prior to deployment. Regardless of the deployment, the axial cavity advantageously reduces the material volume of the inner central conductor relative to a solid inner conductor of equivalent outer diameter, thereby reducing weight and/or cost of the coaxial cable. Implementations may include one or more of the following features.

In some implementations, the axial cavity extends continuously from the first end of the inner central conductor to the second end of the inner central conductor. In some implementations, the internal wall defining the axial cavity is concentric with the external wall of the inner central conductor. In some implementations, the axial cavity has a diameter between 5% and 70% of an outer diameter of the inner central conductor. In some implementations, the inner central conductor consists essentially of copper, aluminum, or an alloy thereof and the axial cavity reduces a metal volume by at least 10%. In some implementations, the coaxial cable is configured to maintain a characteristic impedance within ±5% of a nominal impedance of the same cable constructed with a solid inner conductor.

In some implementations, the thickness of the inner central conductor is defined as a width between the internal wall and the external wall of the inner central conductor. In some implementations, the thickness of the inner central conductor is defined as a width between the internal wall and the external wall of the inner central conductor, and the thickness of the inner central conductor is based on determination of signal attenuation percentage using skin depth formula for the inner central conductor. The skin depth formula is determined based on a skin effect. In some implementations, the skin depth is a distance from the external wall of the inner central conductor where a current density is a predefined percentage of the current density at the external wall of the inner central conductor based on a design parameter. In some implementations, the skin depth is based on a frequency of a signal flowing through the inner central conductor.

In some implementations, the attenuation at a specified frequency increases by less than 5% relative to a cable having a solid inner conductor of identical outer diameter.

In another aspect, an exemplary embodiment of the present disclosure may provide a method of manufacturing a coaxial cable. In one embodiment, the method may include: forming an inner central conductor having an axial cavity extending along a longitudinal axis; applying an insulator layer onto an external wall of the inner central conductor; forming or applying a shielding conductor around the insulator layer; and extruding or applying an outer jacket around the shielding conductor. In some embodiments, the inner central conductor may be formed by extruding a tubular metallic conductor. For example, to form the axial cavity that extends along the longitudinal axis the inner central conductor, a solid rod may be drawn around a mandrel to form the axial cavity.

In one aspect, an exemplary embodiment of the present disclosure may provide a coaxial cable. The coaxial cable comprises an inner central conductor, an insulative core, an insulator layer, a shielding conductor, and an outer jacket. In accordance with the disclosed embodiments, the inner central conductor defines an axial cavity extending along a longitudinal axis of the inner central conductor. Inclusion of the axial cavity in the inner central conductor may reduce the weight and/or the cost of the coaxial cable in comparison to traditional coaxial cables that implement a solid inner central conductor. The insulative core may be disposed within the axial cavity. The insulative core is composed of a material having a dielectric constant less than that of the inner central conductor. For instance, in some implementations, the insulative core may have a dielectric constant less than 3.0. The insulative core may provide internal structural support to the inner central conductor while reducing the metal mass of the inner central conductor. In addition to reducing the weight and/or the cost of the coaxial cable, the insulative core may also provide mechanical stability to resist conductor deformation during bending.

In some embodiments, the insulator layer may surround the inner central conductor. The shielding conductor may be disposed around the insulator layer. For example, in some implementations, the shielding conductor may be disposed around an external periphery of the insulator layer. The outer jacket may surround the shielding conductor. For example, in one implementation, the insulator layer and the shielding conductor may be disposed between an external wall of the inner central conductor and the outer jacket.

Implementations may include one or more of the following features. The insulative core may comprise, for example, a polymeric material, paper, or a composite material. For instance, in some implementations, the insulative core comprises a polymeric material or plastic material, whereas in other implementations, the insulative core comprises a paper material.

In some implementations, the inner central conductor comprises an external wall, and an internal wall formed therein that defines the axial cavity through the inner central conductor. The thickness of the inner central conductor may be defined as a width between the internal wall and the external wall of the inner central conductor. In some implementations, the thickness of the inner central conductor is based on determination of signal attenuation percentage using a skin depth formula for the inner central conductor, where the skin depth formula is determined based on the skin effect. For example, the skin depth may refer to a distance from the external wall of the inner central conductor where a current density is a predefined percentage of the current density at the external wall of the inner central conductor based on a design parameter. The skin depth is based on a frequency of a signal flowing through the inner central conductor.

In some implementations, the axial cavity may be partially filled, leaving a longitudinal channel extending along the coaxial cable.

In another aspect, an exemplary embodiment of the present disclosure may provide a method of manufacturing a coaxial cable. In one embodiment, the method may include: forming an inner central conductor having an axial cavity extending along a longitudinal axis; forming an insulative core in the axial cavity; applying an insulator layer onto an external wall of the inner central conductor; forming or applying a shielding conductor around the insulator layer; and extruding or applying an outer jacket around the shielding conductor. In some embodiments, the inner central conductor may be formed by extruding a tubular metallic conductor. For example, to form the axial cavity that extends along the longitudinal axis of the inner central conductor, a solid rod may be drawn around a mandrel to form the axial cavity. In some embodiments, the insulative core may be inserted into the axial cavity. In other embodiments, the insulative core may be continuously co-extruded with the inner central conductor (e.g., continuous co-extrusion of the inner conductor and the insulative core).

Further aspects, features, applications, and advantages of the disclosed technology, as well as the structure and operation of various examples, are described in detail below with reference to the accompanying drawings. It is noted that the disclosed technology is not limited to the specific examples described herein. Such examples are presented herein for illustrative purposes only. Additional examples will be apparent to persons skilled in the relevant art(s) based on the teachings contained herein.

### BRIEF DESCRIPTION OF THE SEVERAL VIEWS OF THE DRAWINGS

For a better understanding of the present disclosure, non-limiting and non-exhaustive examples of the present disclosure are described with reference to the following drawings, in which:

FIG. 1A is a diagram illustrating skin depth on a cross-sectional view of a conductor according to aspects of the disclosed technology;

FIG. 1B is a graph illustrating a relation between an amplitude of current flowing through the conductor and a depth of the conductor of FIG. 1 according to aspects of the disclosed technology;

FIGS. 2A and 2B are diagrams illustrating a side view and a sectional view of a coaxial cable in which aspects of the technology may be employed;

FIGS. 3A and 3B are diagrams illustrating a side view and a sectional view of another coaxial cable in which aspects of the technology may be employed;

FIG. 4 is a table that illustrates the relation between a frequency of signal flowing through the conductor, a signal attenuation percentage in the conductor, and a thickness of the conductor according to aspects of the disclosed technology;

FIG. 5 is a flowchart illustrating a method of manufacturing a coaxial cable in accordance with the disclosed embodiments; and

FIG. 6 is a flowchart illustrating another method of manufacturing a coaxial cable in accordance with the disclosed embodiments.

In the drawings, similar reference numerals refer to similar parts throughout the drawings unless otherwise specified. These drawings are not necessarily drawn to scale.

### DETAILED DESCRIPTION

The specification and accompanying drawings disclose one or more exemplary embodiments that incorporate the features of the present disclosure. The scope of the present disclosure is not limited to the disclosed embodiments. The disclosed embodiments merely exemplify the present disclosure, and modified versions of the disclosed embodiments are also encompassed by the present disclosure. Embodiments of the present disclosure are defined by the claims appended hereto.

It is noted that any section/subsection headings provided herein are not intended to be limiting. Any embodiments described throughout this specification, and disclosed in any section/subsection may be combined with any other embodiments described in the same section/subsection and/or a different section/subsection in any manner.

As described above, traditional coaxial cables normally have a central conductor, sometimes referred to as a core, that is made of a solid metal material. For example, traditional coaxial cables may utilize materials like copper and aluminum that may add weight and/or limit their flexibility. This may limit the utilization of traditional coaxial cables in some applications where weight and flexibility are important. Additionally, materials like copper may also add to manufacturing costs. Further, traditional coaxial cables may not perform optimally at very high frequencies that may be required for emerging technologies and applications, such as aerospace, portable electronics, and medical devices. Additionally, the weight of a coaxial cable may impact overall system performance and operational efficiency. Considering the foregoing, there is a need for a technical solution to overcome the challenges associated with the traditional coaxial cables.

To address these challenges, a coaxial cable is provided having an inner central conductor, an insulator layer that surrounds the inner central conductor, a shielding conductor disposed on an external periphery of the insulator layer, and an outer jacket that covers the shielding conductor. In accordance with the disclosed embodiments, the inner central conductor has an axial cavity defined therein to reduce the weight and/or the cost of the coaxial cable. In some implementations, the axial cavity is empty and defines a hollow space through the inner central conductor. In such implementations, the inner central conductor may thus have the hollow axial cavity defined by an internal wall of the inner central conductor. In other implementations, an insulative core may be disposed or formed within the axial cavity. In some, but not all, implementations, the insulative core may be made of various materials, such as, polymeric, plastic or paper materials, as two non-limiting examples. In some implementations, the axial cavity may extend along a longitudinal axis of the inner central conductor and through the inner central conductor. For example, in one implementation, the inner central conductor has an external wall, and an internal wall formed therein that defines the axial cavity, where the insulator layer and the shielding conductor may be disposed between the external wall of the inner central conductor and the outer jacket. As explained in greater detail below, regardless of the implementation, inclusion of the axial cavity in the inner central conductor may reduce the weight and/or the cost of the coaxial cable in comparison to traditional coaxial cables that implement a solid inner central conductor.

Utilizing an inner central conductor having an axial cavity defined therein is possible due to the “skin effect.” To explain further, at higher frequencies, due to the skin effect, high frequency signals may travel along an outer portion of the inner central conductor. In other words, at high frequencies, alternating currents (AC) do not distribute uniformly across the cross-section of a conductor. Instead, they tend to flow near the surface. This occurs because the changing magnetic fields associated with AC induce opposing eddy currents within the conductor, which cancel out the flow of current in the inner regions.

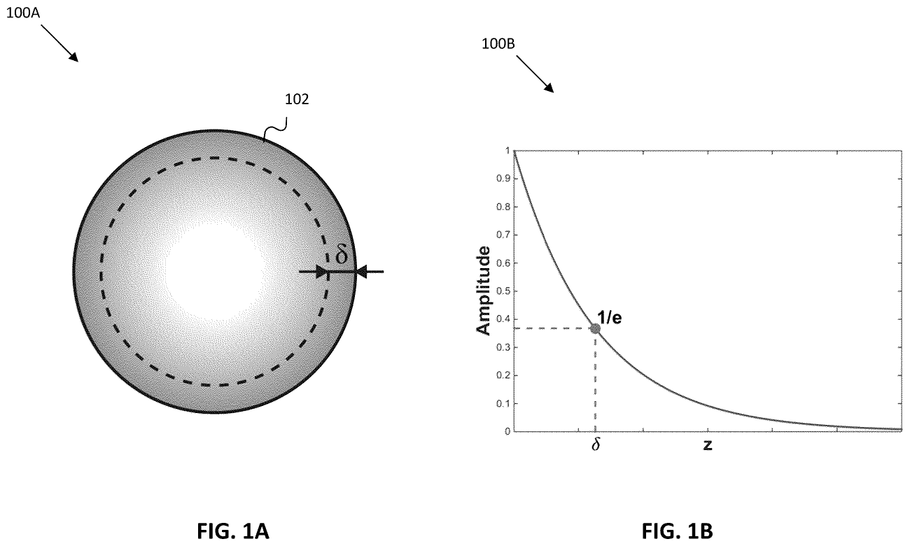

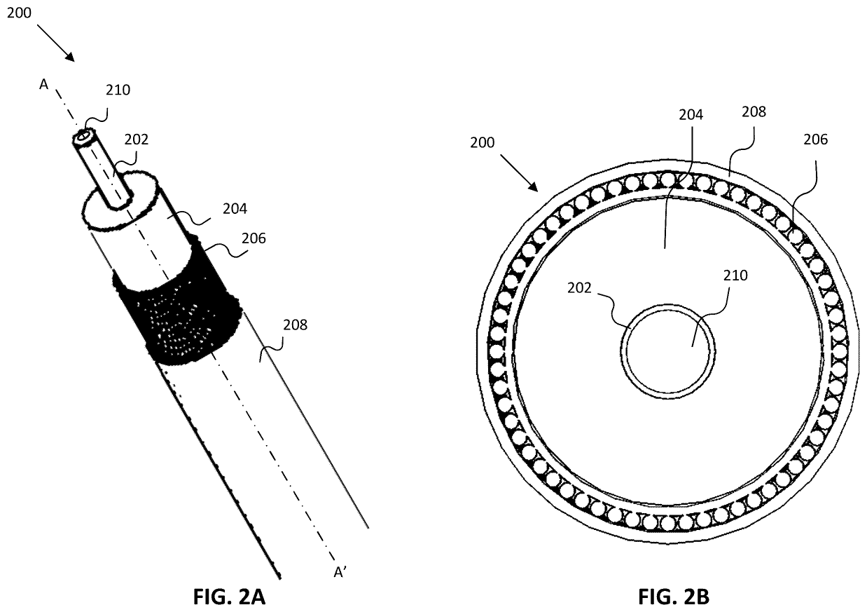

By taking the advantage of the skin effect, the inner central conductor described above may be implemented to reduce the weight and/or cost of the high-speed coaxial cable by eliminating the central portion of the inner central conductor and leaving it hollow or filing the central portion with lighter and/or lower cost materials, while retaining radio frequency (RF) performance characteristics that are the same or superior in comparison to traditional coaxial cables. Prior to describing various coaxial cables in accordance with the disclosed embodiments with reference to FIGS. 2A-6, the concept of skin depth δ will be described with reference to FIGS. 1A and 1B.

FIG. 1A is a diagram 100A illustrating skin depth δ on a cross-sectional view of a conductor 102 according to aspects of the disclosed technology. FIG. 1B is a graph illustrating a relation between an amplitude of current flowing through conductor 102 and a depth (z) of the conductor 102 according to aspects of the disclosed technology. Referring now to FIGS. 1A and 1B, generally, skin effect is the tendency of an alternating current (AC) to distribute itself within the conductor 102 such that the current density is more predominant near the surface of the conductor 102 with the remaining conductor body unused relative to the electrical current flow as shown in FIG. 1A. The remaining conductor body is unused relative to the electrical current flow because the current density typically decays with distance therewithin away from the surface of the conductor 102. In one embodiment, the current density decreases exponentially from the surface of the conductor 102 towards the inside of the conductor 102 as shown in FIG. 1A and FIG. 1B.

The electrical current flows mostly near the outer portion or surface of the conductor 102, which may be referred to as the skin of the conductor 102. A depth from the surface of the conductor 102 until which majority of the electrical current flows is referred to as the skin depth δ. In one embodiment, based on the skin effect, an amplitude of a signal flowing through the conductor 102 at a particular depth (z) may be determined based on an equation (1) given below:

$$A ( z ) = {A}_{0} {e}^{\frac{- z}{δ}} \qquad ( 1 )$$

where,
A(z) is the amplitude at depth z,
A₀ is the amplitude at the surface of the conductor (at z=0)

For instance, the skin depth of the conductor 102 may be defined as a distance from an external wall or an external surface of the conductor 102 towards a center of the conductor 102 where a current density is a certain predefined percentage of the current density at the external wall of the conductor 102 (e.g., thirty seven percent of the current density at the external wall of the conductor 102) based on the design parameter required for the operation of the coaxial cable 100. In one embodiment, the design parameter corresponds to the requirements of a desired ampacity, a desired RF performance, a desired weight, and a desired flexibility of the coaxial cable 100. The skin depth may define an electrical signal conducting path that is active in transmission and/or communication, while the conductor 102 may be defined as the body that is capable of conducting the electrical signal.

At high frequencies, the skin depth may become much smaller. For example, at hundred megahertz (MHz) in copper, the skin depth may be 6.52 micrometer (μm) and at ten gigahertz (GHz) in copper, the skin depth may be 0.652 μm. Signal attenuation may be defined as the loss of signal strength as the signal travels through a medium. At higher frequency the current density may be confined to a thinner layer near the surface of the conductor 102 which increases the AC resistance of the conductor 102, thereby resulting in greater signal attenuation due to increased conductor losses and dielectric losses. At lower frequency, the skin depth may be larger and allow the current density to flow through a greater cross-sectional area of the conductor, reducing the AC resistance and signal attenuation.

Having provided that overview of the concept of skin depth δ, various non-limiting examples of coaxial cables in accordance with the disclosed embodiments will now be described with reference to FIGS. 2A-6.

FIGS. 2A and 2B are diagrams illustrating a side view and a sectional view of a coaxial cable 200 in which aspects of the technology may be employed. The coaxial cable 200 may include an inner central conductor 202, an insulator layer 204 that surrounds the inner central conductor 202, a shielding conductor 206 (also sometimes called a shield), and an outer jacket 208 (also sometimes called as a sheath) that are concentrically arranged. The inner central conductor 202 may provide a signal path to connect different devices to carry signals between the devices. The inner central conductor 202 may be positioned at the core of the coaxial cable 200 and may be configured to carry a signal, for example, a range of electrical current, a radio frequency (RF) signal, an analog signal, and/or electronic digital signals. The insulator layer 204 surrounds the central conductor 202, and may be made of non-conductive materials like polyethylene or Teflon, or other dielectric materials. The insulator layer 204 helps to ensure proper and consistent spacing between the inner central conductor 202 and the shielding conductor 206, and provides insulation and the desired impedance value to reduce energy loss. The shielding conductor 206 may provide electrical isolation and serves as a return path for signals. The shielding conductor 206 helps protect the inner central conductor 202 from electromagnetic interference (EMI). The shielding conductor 206 may be made of various materials, such as a layer of woven copper braid, aluminum foil, or a combination thereof. The outer jacket 208 is a protective layer that helps protect the coaxial cable 200 from environmental factors like moisture, heat, and mechanical damage, while providing mechanical strength to the coaxial cable. The outer jacket 208 may be made of plastic, rubber, or similar materials. The concentric arrangement of these components 202-208 helps ensure that the electric and magnetic fields carrying the signal remain confined within the cable, preventing interference and maintaining signal integrity.

As noted above, the inner central conductor 202 may have an axial cavity 210 defined by an internal wall of the inner central conductor 202. The axial cavity 210 may extend along a longitudinal axis AA′ of the coaxial cable 200 (also referred to herein as a central axis AA′). In some embodiments, such as those illustrated in FIGS. 2A and 2B, the axial cavity is empty. Utilization of the inner central conductor 202 having an axial cavity which is empty, reduces the weight and/or cost of the coaxial cable 200 as compared to the traditional coaxial cables while maintaining the similar RF performance and increased flexibility as compared to the traditional coaxial cables.

In one embodiment, the main portion of the inner central conductor 202 may be formed from materials such as copper, aluminum, silver, copper-clad aluminum (CCA), copper-clad steel (CCS), or silver-coated copper-clad steel (SCCCS), and the like. For example, the inner central conductor 202 may be formed from any type of conductive metal or alloy. The inner central conductor 202 may have configurations such as the clad, the hollow, the stranded hollow, or the like.

In one embodiment, the thickness of the inner central conductor 202 is based on skin effect. The thickness of the inner central conductor 202 may be defined as a width between an internal wall and the external wall of the inner central conductor 202. The thickness of the inner central conductor 202 may be based on determination of signal attenuation percentage using a skin depth formula for the inner central conductor 202. The skin depth formula is determined based on the skin effect. In one embodiment, the skin depth is a distance from the external wall of the inner central conductor 202 towards the center of the inner central conductor 202 where a current density is the predefined percentage (e.g., thirty seven percent) of the current density at the external wall of the inner central conductor 202 based on the design parameter. The skin depth may be determined based on a frequency of a signal flowing through the inner central conductor 202. At higher frequencies, the electrical current flows through an outer portion of the inner central conductor 202 due to the skin effect as described above in conjunction with FIGS. 1A and 1B.

For high-frequency signals, the thickness of the inner central conductor 202 may become limited to the skin depth, rather than the full cross-sectional area of the inner central conductor 202. For the coaxial cable 200 designed to carry high-frequency signals (e.g., 1 GHz) may require the inner central conductor 202 with a large surface area to minimize the signal attenuation as the skin depth may be very small which results in utilization of the inner central conductor 202 having a large diameter to increase the effective area. For the coaxial cable 200 designed to carry low-frequency signals (e.g., 60 Hertz (Hz)) may allow utilization of the inner central conductor 202 having a small diameter as the skin depth may be larger.

The insulator layer 204 may surround the inner central conductor 202. As used herein, the phrase “surrounded by” refers to the inner layer generally being encased by the outer layer. However, it is understood that the inner layer may be “surrounded by” the outer layer without the inner layer being immediately adjacent to the outer layer. The term “surrounded by” thus allows for the possibility of intervening layers.

The insulator layer 204 separates the inner central conductor 202 from the shielding conductor 206 and provide the capacitance to maintain the correct impedance of the coaxial cable 200, preventing short circuits, and ensure efficient signal transmission. The insulator layer 204 may minimize signal loss and distortion by providing the stable medium through which the electromagnetic wave may propagate. The insulator layer 204 may be formed by using various materials including, but not limited to, PE, foamed polyethylene, PTFE, PVC, polystyrene, or some combination thereof. The actual material used in the formation of the insulator layer 204 may be indicated by the particular application/environment contemplated.

The shielding conductor 206 may be disposed on the external periphery of the insulator layer 204. The shielding conductor 206 (or sheathing) is an important layer designed to protect signal integrity by preventing the external EMI and the RFI. The shielding conductor 206 may provide the grounding path for the electromagnetic noise and protect the inner central conductor 202 from external electromagnetic fields that may cause noise and signal degradation. Further, the shielding conductor 206 may prevent the signals carried by the inner central conductor 202 from leaking and interfering with nearby electronic devices. Various types of shielding conductor 206 may include, but not limited to, braided shield, foil shield, combination shield (foil+braided), and quad shield.

The outer jacket 208 may cover the shielding conductor 206. The insulator layer 204 and the shielding conductor 206 may be disposed between the inner central conductor 202 and the outer jacket 208. The outer jacket 208 may provide the protection and mechanical strength to the coaxial cable 200. The outer jacket 208 may shield the inner central conductor 202 from physical damage due to abrasion and other mechanical stresses. The outer jacket 208 may serve to protect the inner central conductor 202 from external contaminants, such as dust, moisture, and oils. The outer jacket 208 may enhance the overall insulation of the coaxial cable 200 to prevent electrical shocks and short circuits.

The outer jacket 208 may be formed from the variety of materials including, but not limited to, polyethylene (PE), high-density polyethylene (HDPE), low-density polyethylene (LDPE), linear low-density polyethylene (LLDPE), rubberized polyvinyl chloride (PVC), or some combination thereof. The actual material used in the formation of the outer jacket 208 may be indicated by the particular application/environment contemplated.

In some implementations, the axial cavity 210 extends continuously from a first end of the inner central conductor 202 to a second end of the inner central conductor 202. In some implementations, the internal wall defining the axial cavity 210 is concentric with the external wall of the inner central conductor 202. In some implementations, the axial cavity 210 has a diameter between 5% and 70% of an outer diameter of the inner central conductor 202. In some implementations, the inner central conductor 202 consists essentially of copper, aluminum, or an alloy thereof, and the axial cavity 210 reduces a metal volume by at least 10%. In some implementations, the coaxial cable is configured to maintain a characteristic impedance within ±5% of a nominal impedance of the same cable constructed with a solid inner conductor.

In some implementations, the thickness of the inner central conductor 202 is defined as a width between the internal wall and the external wall of the inner central conductor 202. The thickness of the inner central conductor 202 is based on determination of signal attenuation percentage using a skin depth formula for the inner central conductor 202. The skin depth formula is determined based on a skin effect. In some implementations, the skin depth is a distance from the external wall of the inner central conductor 202 where a current density is a predefined percentage of the current density at the external wall of the inner central conductor 202 based on a design parameter. In some implementations, the skin depth is based on a frequency of a signal flowing through the inner central conductor 202.

In some implementations, the attenuation at a specified frequency increases by less than 5% relative to a cable having a solid inner conductor of identical outer diameter.

The coaxial cable 200 may have applications in industries where weight and flexibility are important, such as in aerospace, portable electronics, and medical devices. In an embodiment, the coaxial cable 200 may be used in the aerospace industries including spacecraft, launch vehicles, satellites, and other space-related components.

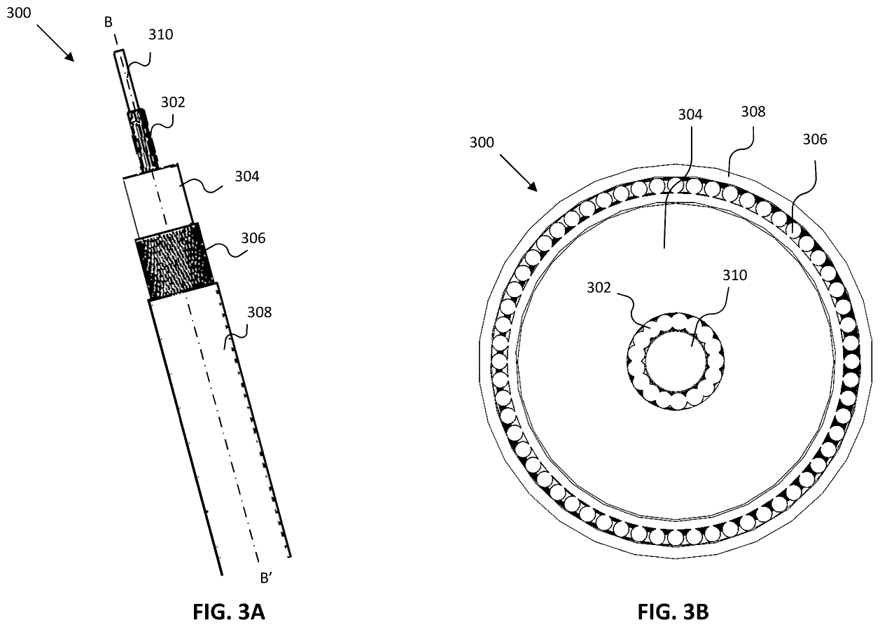

FIGS. 3A and 3B are diagrams illustrating a side view and a sectional view of a coaxial cable 300 in which aspects of the technology may be employed. The coaxial cable 300 may include an inner central conductor 302, an insulator layer 304 that surrounds the inner central conductor 302, a shielding conductor 306 (also sometimes called a shield), an outer jacket 308 (also sometimes called a sheath), and an insulative core 310 that are concentrically arranged.

The inner central conductor 302 may provide a signal path to connect different devices to carry signals between the devices. The inner central conductor 302 may be positioned at the core of the coaxial cable 300 and may be configured to carry a signal, for example, a range of electrical current, a radio frequency (RF) signal, an analog signal, and/or electronic digital signals.

The insulator layer 304 may surround the central conductor 302, and may be made of non-conductive materials like polyethylene or Teflon, or other dielectric materials. The insulator layer 304 helps to ensure proper and consistent spacing between the inner central conductor 302 and the shielding conductor 306, and provides insulation to reduce energy loss.

The shielding conductor 306 may be disposed around the insulator layer 304. For example, in some implementations, the shielding conductor 306 may be disposed around an external periphery of the insulator layer 304. The shielding conductor 306 may provide electrical isolation and serves as a return path for signals. The shielding conductor 306 helps protect the inner central conductor 302 from electromagnetic interference (EMI). The shielding conductor 306 may be made of various materials, such as a layer of woven copper braid, aluminum foil, or a combination thereof.

The outer jacket 308 is a protective layer that helps protect the coaxial cable 300 from environmental factors like moisture, heat, and mechanical damage, while providing mechanical strength to the coaxial cable. The outer jacket 308 may be made of plastic, rubber, or similar materials. The outer jacket 308 may surround the shielding conductor 306. For example, in one implementation, the insulator layer 304 and the shielding conductor 306 may be disposed between an external wall of the inner central conductor 302 and the outer jacket 308. The concentric arrangement of these components 302-310 helps ensure that the electric and magnetic fields carrying the signal remain confined within the cable, preventing interference and maintaining signal integrity.

As noted above, in accordance with the disclosed embodiments, the inner central conductor 302 defines an axial cavity 310 extending along a longitudinal axis of the inner central conductor 302.

In some embodiments, the inner central conductor 302 comprises an external wall, and an internal wall formed therein that defines the axial cavity 310 through the inner central conductor 302. In other words, the axial cavity is defined by the internal wall of the inner central conductor 302, and extends along a longitudinal axis BB′ of the coaxial cable 300.

As explained above, inclusion of the axial cavity 310 in the inner central conductor 302 may reduce the weight and/or the cost of the coaxial cable 300 in comparison to traditional coaxial cable 300s that implement a solid inner central conductor 302.

In some embodiments, such as those illustrated in FIGS. 3A and 3B, the insulative core 310 may be disposed within the axial cavity 310. The insulative core 310 may be disposed in the hollow axial cavity (defined by the internal wall of the inner central conductor 302) that extends along the longitudinal axis BB′ of the coaxial cable 300. The insulative core 310 may be formed from any type of insulative or dielectric material. The insulative core 310 may comprise, for example, a polymeric material, paper material, or a composite material. For instance, in one embodiment, the insulative core 310 may be made of a polymeric material, such as a plastic material, in which case it may be referred to as a polymeric core (e.g., a plastic core). In another embodiment, the insulative core 310 may be made of a paper material and may be referred to as a paper core. In some embodiments, the insulative core 310 may be composed of a material having a dielectric constant less than that of the inner central conductor 302. For instance, in some implementations, the insulative core 310 may have a dielectric constant less than 3.0. The insulative core 310 may provide internal structural support to the inner central conductor 302 while reducing the metal mass of the inner central conductor 302. While FIGS. 3A and 3B show an embodiment where the axial cavity 310 is fully filled by the insulative core 310, it should be appreciated that in other embodiments, the axial cavity 310 may be partially filled by the insulative core 310, leaving a longitudinal channel extending along the coaxial cable 300.

Utilization of the inner central conductor 302 and the insulative core 310 reduces the weight and/or cost of the coaxial cable 300 as compared to the traditional coaxial cables while maintaining the similar RF performance and increased flexibility as compared to the traditional coaxial cables. In addition to reducing the weight and/or the cost of the coaxial cable 300, the insulative core 310 may also provide mechanical stability to resist conductor deformation during bending. It will be understood by a person skilled in the art that utilization of the inner central conductor 202 with the axial cavity 210 that is empty and not having a filled core such as the insulative core 310, reduces the weight and/or cost of the coaxial cable 200 even further as compared to the coaxial cable 300 while maintaining the similar RF performance and increased flexibility as compared to the coaxial cable 300.

In one embodiment, the main portion of the inner central conductor 302 may be formed from materials such as copper, aluminum, silver, copper-clad aluminum (CCA), copper-clad steel (CCS), or silver-coated copper-clad steel (SCCCS), and the like. For example, the inner central conductor 302 may be formed from any type of conductive metal or alloy. The inner central conductor 302 may have configurations such as clad, hollow, stranded hollow, or the like. In one embodiment, the inner central conductor 302 has a stranded hollow configuration such that multiple strands of electric wire are wound in a cylindrical shape to maintain a hollow space at the center.

In one embodiment, the thickness of the inner central conductor 302 may be defined as a width between the internal wall and an external wall of the inner central conductor 302. The thickness of the inner central conductor 302 may be based on determination of signal attenuation percentage using the skin depth formula for the inner central conductor 302. The skin depth formula is determined based on the skin effect. In one embodiment, the skin depth is a distance from the external wall of the inner central conductor 302 towards the center of the inner central conductor 302 where a current density is a predefined percentage (e.g., thirty seven percent) of the current density at the external wall of the inner central conductor 302 based on the design parameter. The skin depth may be determined based on a frequency of a signal flowing through the inner central conductor 302. At higher frequencies, the electrical current flows through an outer portion of the inner central conductor 302 due to the skin effect as described above in conjunction with FIGS. 1A and 1B.

The insulator layer 304 may surround the inner central conductor 302. As used herein, the phrase “surrounded by” refers to an inner layer generally being encased by an outer layer. However, it is understood that an inner layer may be “surrounded by” an outer layer without the inner layer being immediately adjacent to the outer layer. The term “surrounded by” thus allows for the possibility of intervening layers.

The insulator layer 304 separates the inner central conductor 302 from the shielding conductor 306 and provides the capacitance to maintain the correct impedance of the coaxial cable 300, preventing short circuits, and ensuring efficient signal transmission. The insulator layer 304 may minimize signal loss and distortion by providing a stable medium through which an electromagnetic wave may propagate. The insulator layer 304 may be formed by using various materials including, but not limited to, polyethylene (PE), foamed polyethylene, Teflon (PTFE), polyvinyl chloride (PVC), polystyrene, or some combination thereof. The actual material used in the formation of the insulator layer 304 may be indicated by the particular application/environment contemplated.

The shielding conductor 306 may be disposed on the external periphery of the insulator layer 304. The shielding conductor 306 (or sheathing) is an important layer designed to protect signal integrity by preventing external EMI and radio frequency interference (RFI). The shielding conductor 306 may provide the grounding path for the electromagnetic noise and protect the inner central conductor 302 from external electromagnetic fields that may cause noise and signal degradation. Further, the shielding conductor 306 may prevent the signals carried by the inner central conductor 302 from leaking and interfering with nearby electronic devices. Various types of shielding conductor 306 may include, but not limited to, braided shield, foil shield, combination shield (foil+braided), and quad shield.

The outer jacket 308 may cover the shielding conductor 306. The insulator layer 304 and the shielding conductor 306 may be disposed between the inner central conductor 302 and the outer jacket 308. The outer jacket 308 may provide the protection and mechanical strength to the coaxial cable 300. The outer jacket 308 may shield the inner central conductor 302 from physical damage due to abrasion and other mechanical stresses. The outer jacket 308 may serve to protect the inner central conductor 302 from external contaminants, such as dust, moisture, and oils. The outer jacket 308 may enhance the overall insulation of the coaxial cable 300 to prevent electrical shocks and short circuits.

The outer jacket 308 may be formed from a variety of materials including, but not limited to, PE, HDPE, LDPE, LLDPE, PVC, or some combination thereof. The actual material used in the formation of the outer jacket 308 may be indicated by the particular application/environment contemplated.

The outer jacket 308 may be formed from a variety of materials including, but not limited to, PE, HDPE, LDPE, LLDPE, PVC, or some combination thereof. The actual material used in the formation of the outer jacket 308 may be indicated by the particular application/environment contemplated.

The coaxial cable 300 may have applications in industries where weight and flexibility are important, such as in aerospace, portable electronics, and medical devices. In an embodiment, the coaxial cable 300 may be used in the aerospace industries including spacecraft, launch vehicles, satellites, and other space-related components.

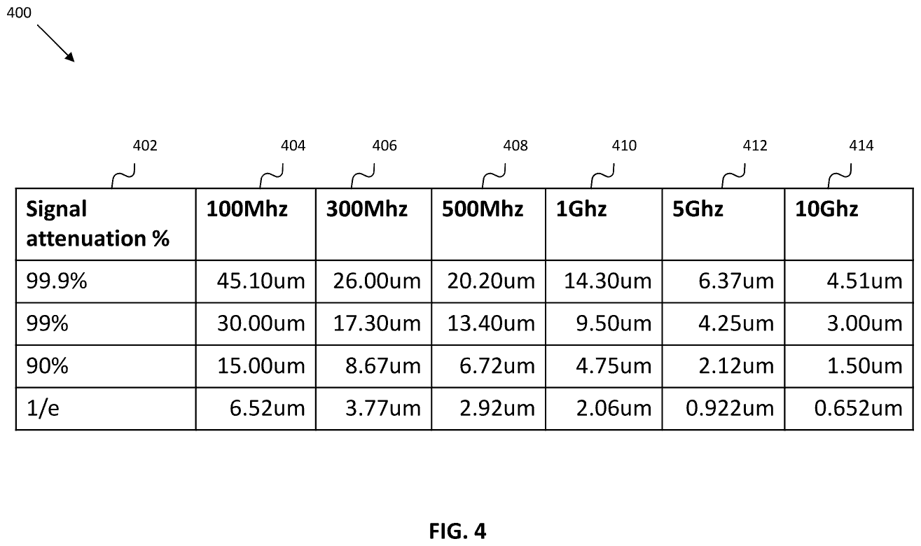

FIG. 4 is a table 400 that illustrates the relation between the frequency, the signal attenuation percentage in the inner central conductor 202 or 302, and the thickness of the inner central conductor 202 or 302 according to aspects of the disclosed technology. In one embodiment, a depth of the inner central conductor 202 or 302 at which a signal may flow at a particular amplitude may be based on the equation (1), and may be determined based on an equation (2) which corresponds to the skin depth formula given below:

$$z = \vert δ ln ( \frac{{A}_{0}}{A ( z )} ) \vert \qquad ( 2 )$$

The table 400 comprises a “signal attenuation” column 402, a “100 MHz frequency” column 404, a “300 MHz frequency” column 406, a “500 MHz frequency” column 408, a “1 GHz frequency” column 410, a “5 GHz frequency” column 412, and a “10 GHz frequency” column 414.

Each of the second through seventh columns provides a depth value at which a signal attenuation is a value mentioned in the first column for a frequency mentioned in the first row of the second through seventh columns. In an exemplary embodiment, at “100 MHz frequency” column 404, a frequency of the signal flowing through the inner central conductor 202 or 302 is 100 MHz. At a depth of 45.10 μm the signal attenuation is 99.9 percent, at a depth of 30.00 μm the signal attenuation is 99 percent, at a depth of 15.00 μm the signal attenuation is 90 percent, and at a depth of 6.52 μm, the signal attenuation is 1/e, i.e., 33 percent.

At “300 MHz frequency” column 406, a frequency of the signal flowing through the inner central conductor 202 or 302 is 300 MHz. At a depth of 26.00 μm the signal attenuation is 99.9 percent, at a depth of 17.30 μm the signal attenuation is 99 percent, at a depth of 8.67 μm the signal attenuation is 90 percent, and at a depth of 3.77 μm, the signal attenuation is 1/e, i.e., 33 percent.

At “500 MHz frequency” column 408, a frequency of the signal flowing through the inner central conductor 202 or 302 is 500 MHz. At a depth of 20.20 μm the signal attenuation is 99.9 percent, at a depth of 13.40 μm the signal attenuation is 99 percent, at a depth of 6.72 μm the signal attenuation is 90 percent, and at a depth of 2.92 μm, the signal attenuation is 1/e, i.e., 33 percent.

At “1 GHz frequency” column 410, a frequency of the signal flowing through the inner central conductor 202 or 302 is 1 GHz. At a depth of 14.30 μm the signal attenuation is 99.9 percent, at a depth of 9.50 μm the signal attenuation is 99 percent, at a depth of 4.75 μm the signal attenuation is 90 percent, and at a depth of 2.06 μm, the signal attenuation is 1/e, i.e., 33 percent.

At “5 GHz frequency” column 412, a frequency of the signal flowing through the inner central conductor 202 or 302 is 5 GHz. At a depth of 6.37 μm the signal attenuation is 99.9 percent, at a depth of 4.25 μm the signal attenuation is 99 percent, at a depth of 2.12 μm the signal attenuation is 90 percent, and at a depth of 0.922 μm, the signal attenuation is 1/e, i.e., 33 percent.

At “10 GHz frequency” column 414, a frequency of the signal flowing through the inner central conductor 202 or 302 is 10 GHz. At a depth of 4.51 μm the signal attenuation is 99.9 percent, at a depth of 3.00 μm the signal attenuation is 99 percent, at a depth of 1.50 μm the signal attenuation is 90 percent, and at a depth of 0.652 μm, the signal attenuation is 1/e, i.e., 33 percent. Thus, the signal attenuation is higher at greater depths. Further, as the frequency increases the skin depth decreases.

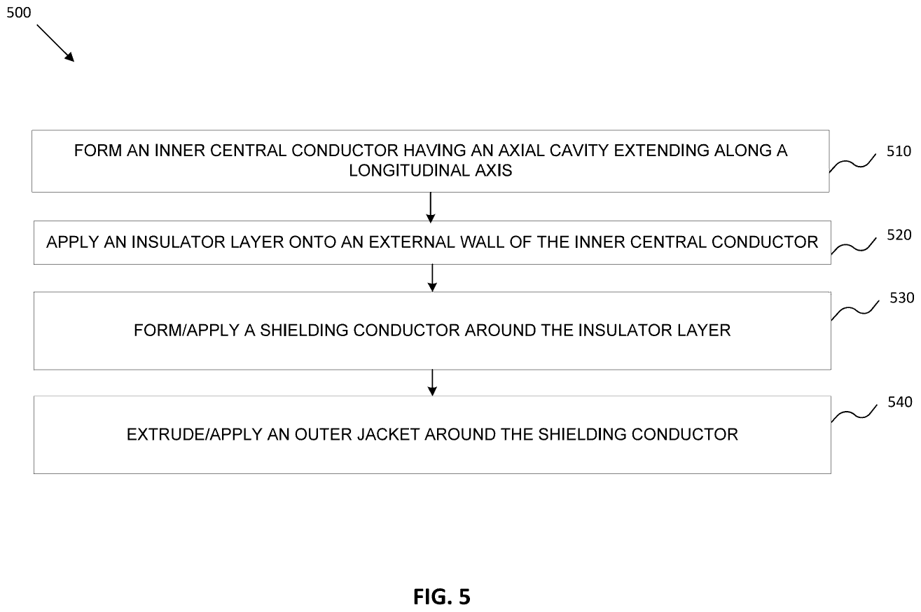

FIG. 5 is a flowchart illustrating a method 500 of manufacturing a coaxial cable in accordance with the disclosed embodiments. At 510, an inner central conductor having an axial cavity extending along a longitudinal axis is formed. In some embodiments, the inner central conductor may be formed by extruding a tubular metallic conductor. For example, a solid rod may be drawn around a mandrel to form the axial cavity that extends along the longitudinal axis of the inner central conductor. At 520, an insulator layer is applied onto an external wall of the inner central conductor. At 530, a shielding conductor may be formed or applied around the insulator layer. At 540, an outer jacket any be extruded or applied around the shielding conductor.

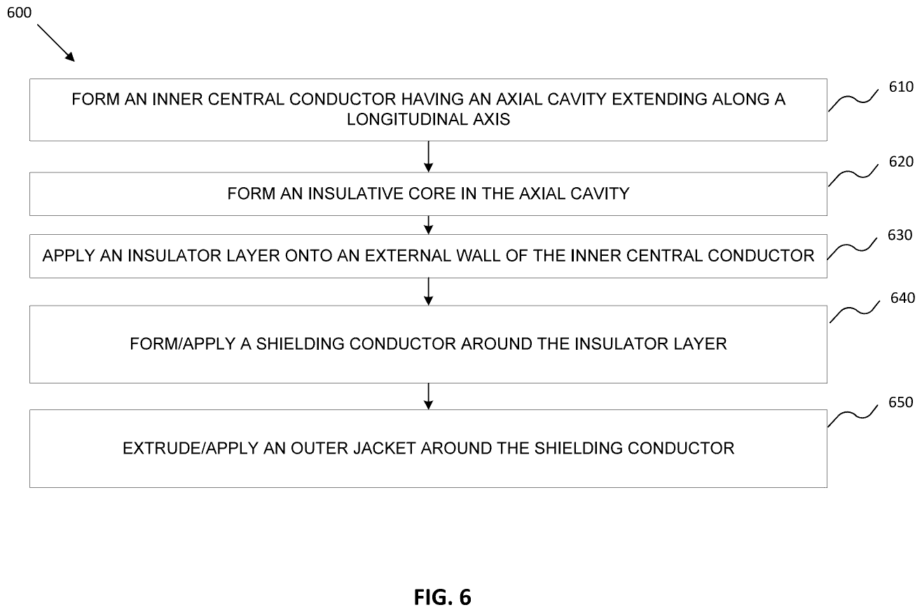

FIG. 6 is a flowchart illustrating another method 600 of manufacturing a coaxial cable in accordance with the disclosed embodiments. At 610, an inner central conductor having an axial cavity extending along a longitudinal axis is formed. In some embodiments, the inner central conductor may be formed by extruding a tubular metallic conductor. For example, to form the axial cavity that extends along the longitudinal axis of the inner central conductor, a solid rod may be drawn around a mandrel to form the axial cavity. At 620, an insulative core is formed in the axial cavity. For example, in some embodiments, the insulative core may be inserted into the axial cavity. In other embodiments, the insulative core may be continuously co-extruded with the inner central conductor (e.g., continuous co-extrusion of the inner conductor and the insulative core). At 630, an insulator layer is applied onto an external wall of the inner central conductor. At 640, a shielding conductor may be formed or applied around the insulator layer. At 650, an outer jacket any be extruded or applied around the shielding conductor.

Various inventive concepts may be embodied as one or more methods, of which an example has been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

While various inventive embodiments have been described and illustrated herein, those of ordinary skill in the art will readily envision a variety of other means and/or structures for performing the function and/or obtaining the results and/or one or more of the advantages described herein, and each of such variations and/or modifications is deemed to be within the scope of the inventive embodiments described herein. More generally, those skilled in the art will readily appreciate that all parameters, dimensions, materials, and configurations described herein are meant to be exemplary and that the actual parameters, dimensions, materials, and/or configurations will depend upon the specific application or applications for which the inventive teachings is/are used. Those skilled in the art will recognize or be able to ascertain using no more than routine experimentation, many equivalents to the specific inventive embodiments described herein. It is, therefore, to be understood that the foregoing embodiments are presented by way of example only and that, within the scope of the appended claims and equivalents thereto, inventive embodiments may be practiced otherwise than as specifically described and claimed. Inventive embodiments of the present disclosure are directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the inventive scope of the present disclosure.

All definitions, as defined and used herein, should be understood to control over dictionary definitions, definitions in documents incorporated by reference, and/or ordinary meanings of the defined terms.

The articles “a” and “an,” as used herein in the specification and in the claims, unless clearly indicated to the contrary, should be understood to mean “at least one.” The phrase “and/or,” as used herein in the specification and in the claims (if at all), should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc. As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of.” “Consisting essentially of,” when used in the claims, shall have its ordinary meaning as used in the field of patent law.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

As used herein in the specification and in the claims, the term “effecting” or a phrase or claim element beginning with the term “effecting” should be understood to mean to cause something to happen or to bring something about. For example, effecting an event to occur may be caused by actions of a first party even though a second party actually performed the event or had the event occur to the second party. Stated otherwise, effecting refers to one party giving another party the tools, objects, or resources to cause an event to occur. Thus, in this example a claim element of “effecting an event to occur” would mean that a first party is giving a second party the tools or resources needed for the second party to perform the event, however the affirmative single action is the responsibility of the first party to provide the tools or resources to cause said event to occur.

When a feature or element is herein referred to as being “on” another feature or element, it can be directly on the other feature or element or intervening features and/or elements may also be present. In contrast, when a feature or element is referred to as being “directly on” another feature or element, there are no intervening features or elements present. It will also be understood that, when a feature or element is referred to as being “connected,” “attached” or “coupled” to another feature or element, it can be directly connected, attached, or coupled to the other feature or element or intervening features or elements may be present. In contrast, when a feature or element is referred to as being “directly connected,” “directly attached” or “directly coupled” to another feature or element, there are no intervening features or elements present. Although described or shown with respect to one embodiment, the features and elements so described or shown can apply to other embodiments. It will also be appreciated by those of skill in the art that references to a structure or feature that is disposed “adjacent” another feature may have portions that overlap or underlie the adjacent feature.

Spatially relative terms, such as “under”, “below”, “lower”, “over”, “upper”, “above”, “behind”, “in front of”, and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if a device in the figures is inverted, elements described as “under” or “beneath” other elements or features would then be oriented “over” the other elements or features. Thus, the exemplary term “under” can encompass both an orientation of over and under. The device may be otherwise oriented (rotated 90 degrees or at other orientations) and the spatially relative descriptors used herein interpreted accordingly. Similarly, the terms “upwardly,” “downwardly,” “vertical,” “horizontal,” “lateral,” “transverse,” “longitudinal,” and the like are used herein for the purpose of explanation only unless specifically indicated otherwise.

Although the terms “first” and “second” may be used herein to describe various features/elements, these features/elements should not be limited by these terms, unless the context indicates otherwise. These terms may be used to distinguish one feature/element from another feature/element. Thus, a first feature/element discussed herein could be termed a second feature/element, and similarly, a second feature/element discussed herein could be termed a first feature/element without departing from the teachings of the present invention.

An embodiment is an implementation or example of the present disclosure. Reference in the specification to “an embodiment,” “one embodiment,” “some embodiments,” “one particular embodiment,” “an example embodiment,” “an exemplary embodiment,” or “other embodiments,” or the like, means that a particular feature, structure, or characteristic described in connection with the embodiments is included in at least some embodiments, but not necessarily all embodiments, of the invention. The various appearances “an embodiment,” “one embodiment,” “some embodiments,” “one particular embodiment,” “an example embodiment,” “an exemplary embodiment,” or “other embodiments,” or the like, are not necessarily all referring to the same embodiments. References in the specification to “an embodiment,” “one embodiment,” “some embodiments,” “one particular embodiment,” “an example embodiment,” “an exemplary embodiment,” or “other embodiments,” or the like, indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to effect such feature, structure, or characteristic in connection with other embodiments whether or not explicitly described.

If this specification states a component, feature, structure, or characteristic “may,” “might,” or “could” be included, that a particular component, feature, structure, or characteristic is not required to be included. If the specification or claim refers to “a” or “an” element, that does not mean there is only one of the element. If the specification or claims refer to “an additional” element, that does not preclude there being more than one of the additional element.

In the discussion, unless otherwise stated, adjectives such as “substantially” and “about” modifying a condition or relationship characteristic of a feature or features of an embodiment of the disclosure, are understood to mean that the condition or characteristic is defined to within tolerances that are acceptable for operation of the embodiment for an application for which it is intended. As used herein in the specification and claims, including as used in the examples and unless otherwise expressly specified, all numbers may be read as if prefaced by the word “about” or “approximately,” even if the term does not expressly appear. The phrase “about” or “approximately” may be used when describing magnitude and/or position to indicate that the value and/or position described is within a reasonable expected range of values and/or positions. For example, a numeric value may have a value that is +/−0.1% of the stated value (or range of values), +/−1% of the stated value (or range of values), +/−2% of the stated value (or range of values), +/−5% of the stated value (or range of values), +/−10% of the stated value (or range of values), etc. Any numerical range recited herein is intended to include all sub-ranges subsumed therein.

Additionally, the method of performing the present disclosure may occur in a sequence different than those described herein. Accordingly, no sequence of the method should be read as a limitation unless explicitly stated. It is recognizable that performing some of the steps of the method in a different order could achieve a similar result.

In the claims, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively.

In the foregoing description, certain terms have been used for brevity, clearness, and understanding. No unnecessary limitations are to be implied therefrom beyond the requirement of the prior art because such terms are used for descriptive purposes and are intended to be broadly construed.

The description and illustration of various embodiments of the disclosure are examples and the disclosure is not limited to the exact details shown or described. While various embodiments of the disclosed subject matter have been described above, it should be understood that they have been presented by way of example only, and not limitation. It will be understood by those skilled in the relevant art(s) that various changes in form and details may be made therein without departing from the spirit and scope of the embodiments as defined in the appended claims. Accordingly, the breadth and scope of the disclosed subject matter should not be limited by any of the above-described exemplary embodiments, but should be defined only in accordance with the following claims and their equivalents.

What is claimed:

1. A coaxial cable, comprising:
an inner central conductor having an external wall and an internal wall defining an axial cavity extending along a longitudinal axis of the inner central conductor;
an insulator layer disposed around the inner central conductor;
a shielding conductor disposed around the insulator layer; and
an outer jacket surrounding the shielding conductor, wherein the axial cavity reduces a material volume of the inner central conductor relative to a solid inner conductor of equivalent outer diameter, thereby reducing weight and/or cost of the coaxial cable.

2. The coaxial cable of claim 1, wherein the thickness of the inner central conductor is defined as a width between the internal wall and the external wall of the inner central conductor.

3. The coaxial cable of claim 1, wherein the thickness of the inner central conductor is based on determination of signal attenuation percentage using skin depth formula for the inner central conductor, and wherein the skin depth formula is determined based on a skin effect.

4. The coaxial cable of claim 3, wherein the skin depth is a distance from the external wall of the inner central conductor where a current density is a predefined percentage of the current density at the external wall of the inner central conductor based on a design parameter.

5. The coaxial cable of claim 3, wherein the skin depth is based on a frequency of a signal flowing through the inner central conductor.

6. The coaxial cable of claim 1, wherein the insulator layer is disposed between the external wall and the outer jacket.

7. The coaxial cable of claim 1, wherein the axial cavity is a hollow axial cavity that extends through the inner central conductor along the longitudinal axis, and wherein the internal wall is formed in the inner central conductor to define the hollow axial cavity.

8. The coaxial cable of claim 1, wherein the insulator layer is disposed around the external wall of the inner central conductor.

9. The coaxial cable of claim 1, wherein the shielding conductor is disposed around an external periphery of the insulator layer.

10. The coaxial cable of claim 1, wherein the shielding conductor is between the external wall and the outer jacket.

11. The coaxial cable of claim 1, wherein the axial cavity extends continuously from a first end of the inner central conductor to a second end of the inner central conductor.

12. The coaxial cable of claim 1, wherein the axial cavity is filled with air.

13. The coaxial cable of claim 1, wherein the internal wall defining the axial cavity is concentric with the external wall of the inner central conductor.

14. The coaxial cable of claim 1, wherein the axial cavity has a diameter between 5% and 70% of an outer diameter of the inner central conductor.

15. The coaxial cable of claim 1, wherein the inner central conductor consists essentially of copper, aluminium, or an alloy thereof and the axial cavity reduces a metal volume by at least 10%.

16. The coaxial cable of claim 1, wherein the coaxial cable is configured to maintain a characteristic impedance within ±5% of a nominal impedance of the same cable constructed with a solid inner conductor.

17. The coaxial cable of claim 1, wherein attenuation at a specified frequency increases by less than 5% relative to a cable having a solid inner conductor of identical outer diameter.

18. A method of manufacturing a coaxial cable, comprising:
forming an inner central conductor having an axial cavity extending along a longitudinal axis;
applying an insulator layer onto an external wall of the inner central conductor;
forming or applying a shielding conductor around the insulator layer; and
extruding or applying an outer jacket around the shielding conductor.

19. The method of claim 18, wherein forming the inner central conductor comprises:
extruding a tubular metallic conductor.

20. The method of claim 18, wherein the axial cavity is formed by drawing a solid rod around a mandrel.
